(19) United States
(12) Patent Application Publication
(10) Pub. No.: US 2021/0183391 A1
(43) Pub. Date: Jun. 17, 2021

(54) METHOD, SYSTEM, AND COMPUTER-READABLE MEDIUM FOR RECOGNIZING SPEECH USING DEPTH INFORMATION

(71) Applicant: GUANGDONG OPPO MOBILE TELECOMMUNICATIONS CORP., LTD., Dongguan (CN)

(72) Inventors: Yuan LIN, Palo Alto, CA (US); Chiuman HO, Palo Alto, CA (US)

(21) Appl. No.: 17/185,200

(22) Filed: Feb. 25, 2021

Related U.S. Application Data
(63) Continuation of application No. PCT/CN2019/102880, filed on Aug. 27, 2019.
(60) Provisional application No. 62/726,595, filed on Sep. 4, 2018.

(51) Int. Cl. G10L 15/25; H04N 5/225; G06T 7/50; G06K 9/46; G06K 9/00; G06T 7/90; G06K 9/62; G10L 15/16; G10L 15/22; G06N 3/08

(52) U.S. Cl. CPC G10L 15/25; H04N 5/2256; G06T 7/50; G06K 9/4652; G06K 9/00281; G06T 7/90; G06T 2207/20084; G10L 15/16; G10L 15/22; G06N 3/08; G06T 2207/30201; G06T 2207/10024; G06K 9/6217

(57) ABSTRACT

In an embodiment, a method includes receiving a plurality of first images including at least a mouth-related portion of a human speaking an utterance, wherein each first image has depth information; extracting a plurality of viseme features using the first images, wherein one of the viseme features is obtained using depth information of a tongue of the human in the depth information of a first image of the first images; determining a sequence of words corresponding to the utterance using the viseme features, wherein the sequence of words comprises at least one word; and outputting, by a human-machine interface (HMI) outputting module, a response using the sequence of words.

### CROSS-REFERENCE TO RELATED APPLICATION

This application is a continuation of International Application No. PCT/CN2019/102880, filed Aug. 27, 2019, which claims priority to U.S. Provisional Application No. 62/726,595, filed Sep. 4, 2018. The entire disclosures of the above-identified applications are incorporated herein by reference.

### BACKGROUND OF THE DISCLOSURE

### 1. Field of the Disclosure

The present disclosure relates to the field of speech recognition, and more particularly, to a method, system, and computer-readable medium for recognizing speech using depth information.

### 2. Description of the Related Art

Automated speech recognition can be used to recognize an utterance of a human, to generate an output that can be used to cause smart devices and robotics to perform actions for a variety of applications. Lipreading is a type of speech recognition that uses visual information to recognize an utterance of a human. It is difficult for lipreading to accurately generate an output.

### SUMMARY

An object of the present disclosure is to propose a method, system, and computer-readable medium for recognizing speech using depth information.

In a first aspect of the present disclosure, a method includes:

receiving, by at least one processor, a plurality of first images including at least a mouth-related portion of a human speaking an utterance, wherein each first image has depth information;

extracting, by the at least one processor, a plurality of viseme features using the first images, wherein one of the viseme features is obtained using depth information of a tongue of the human in the depth information of a first image of the first images;

determining, by the at least one processor, a sequence of words corresponding to the utterance using the viseme features, wherein the sequence of words includes at least one word; and

outputting, by a human-machine interface (HMI) outputting module, a response using the sequence of words.

According to an embodiment in conjunction with the first aspect of the present disclosure, the method further includes:

generating, by a camera, infrared light that illuminates the tongue of the human when the human is speaking the utterance; and

capturing, by the camera, the first images.

According to an embodiment in conjunction with the first aspect of the present disclosure, the step of receiving, by the at least one processor, the first images includes: receiving, by the at least one processor, a plurality of image sets, wherein each image set includes a corresponding second image of the first images, and a corresponding third image, and the corresponding third image has color information augmenting the depth information of the corresponding second image; and the step of extracting, by the at least one processor, the viseme features using the first images includes: extracting, by the at least one processor, the viseme features using the image sets, wherein the one of the viseme features is obtained using the depth information and color information of the tongue correspondingly in the depth information and the color information of a first image set of the image sets.

According to an embodiment in conjunction with the first aspect of the present disclosure, the step of extracting, by the at least one processor, the viseme features using the first images includes:

generating, by the at least one processor, a plurality of mouth-related portion embeddings corresponding to the first images, wherein each mouth-related portion embedding includes a first element generated using the depth information of the tongue; and

tracking, by the at least one processor, deformation of the mouth-related portion such that context of the utterance reflected in the mouth-related portion embeddings is considered using a recurrent neural network (RNN), to generate the viseme features.

According to an embodiment in conjunction with the first aspect of the present disclosure, the RNN includes a bidirectional long short-term memory (LSTM) network.

According to an embodiment in conjunction with the first aspect of the present disclosure, the step of determining, by the at least one processor, the sequence of words corresponding to the utterance using the viseme features includes:

determining, by the least one processor, a plurality of probability distributions of characters mapped to the viseme features; and

determining, by a connectionist temporal classification (CTC) loss layer implemented by the at least one processor, the sequence of words using the probability distributions of the characters mapped to the viseme features.

According to an embodiment in conjunction with the first aspect of the present disclosure, the step of determining, by the at least one processor, the sequence of words corresponding to the utterance using the viseme features includes:

determining, by a decoder implemented by the at least one processor, the sequence of words corresponding to the utterance using the viseme features.

According to an embodiment in conjunction with the first aspect of the present disclosure, the one of the viseme features is obtained using depth information of the tongue, lips, teeth, and facial muscles of the human in the depth information of the first image of the first images.

In a second aspect of the present disclosure, a system includes at least one memory, at least one processor, and a human-machine interface (HMI) outputting module. The at least one memory is configured to store program instructions. The at least one processor is configured to execute the program instructions, which cause the at least one processor to perform steps including:

receiving a plurality of first images including at least a mouth-related portion of a human speaking an utterance, wherein each first image has depth information;

extracting a plurality of viseme features using the first images, wherein one of the viseme features is obtained using depth information of a tongue of the human in the depth information of a first image of the first images; and

determining a sequence of words corresponding to the utterance using the viseme features, wherein the sequence of words includes at least one word.

The HMI outputting module is configured to output a response using the sequence of words.

According to an embodiment in conjunction with the second aspect of the present disclosure, the system further includes: a camera configured to generate infrared light that illuminates the tongue of the human when the human is speaking the utterance; and capture the first images.

According to an embodiment in conjunction with the second aspect of the present disclosure, the step of receiving the first images includes: receiving a plurality of image sets, wherein each image set includes a corresponding second image of the first images, and a corresponding third image, and the corresponding third image has color information augmenting the depth information of the corresponding second image; and the step of extracting the viseme features using the first images includes: extracting the viseme features using the image sets, wherein the one of the viseme features is obtained using the depth information and color information of the tongue correspondingly in the depth information and the color information of a first image set of the image sets.

According to an embodiment in conjunction with the second aspect of the present disclosure, the step of extracting the viseme features using the first images includes: generating a plurality of mouth-related portion embeddings corresponding to the first images, wherein each mouth-related portion embedding includes a first element generated using the depth information of the tongue; and tracking deformation of the mouth-related portion such that context of the utterance reflected in the mouth-related portion embeddings is considered using a recurrent neural network (RNN), to generate the viseme features.

According to an embodiment in conjunction with the second aspect of the present disclosure, the RNN includes a bidirectional long short-term memory (LSTM) network.

According to an embodiment in conjunction with the second aspect of the present disclosure, the step of determining the sequence of words corresponding to the utterance using the viseme features includes: determining a plurality of probability distributions of characters mapped to the viseme features; and determining, by a connectionist temporal classification (CTC) loss layer, the sequence of words using the probability distributions of the characters mapped to the viseme features.

According to an embodiment in conjunction with the second aspect of the present disclosure, the step of determining the sequence of words corresponding to the utterance using the viseme features includes: determining, by a decoder, the sequence of words corresponding to the utterance using the viseme features.

According to an embodiment in conjunction with the second aspect of the present disclosure, the one of the viseme features is obtained using depth information of the tongue, lips, teeth, and facial muscles of the human in the depth information of the first image of the first images.

In a third aspect of the present disclosure, a non-transitory computer-readable medium with program instructions stored thereon is provided. When the program instructions are executed by at least one processor, the at least one processor is caused to perform steps including:

receiving a plurality of first images including at least a mouth-related portion of a human speaking an utterance, wherein each first image has depth information;

extracting a plurality of viseme features using the first images, wherein one of the viseme features is obtained using depth information of a tongue of the human in the depth information of a first image of the first images;
determining a sequence of words corresponding to the utterance using the viseme features, wherein the sequence of words includes at least one word; and

causing a human-machine interface (HMI) outputting module to output a response using the sequence of words.

According to an embodiment in conjunction with the third aspect of the present disclosure, the steps performed by the at least one processor further includes: causing a camera to generate infrared light that illuminates the tongue of the human when the human is speaking the utterance and capture the first images.

According to an embodiment in conjunction with the third aspect of the present disclosure, the step of receiving the first images includes: receiving a plurality of image sets, wherein each image set includes a corresponding second image of the first images, and a corresponding third image, and the corresponding third image has color information augmenting the depth information of the corresponding second image; and the step of extracting the viseme features using the first images includes: extracting the viseme features using the image sets, wherein the one of the viseme features is obtained using the depth information and color information of the tongue correspondingly in the depth information and the color information of a first image set of the image sets.

According to an embodiment in conjunction with the third aspect of the present disclosure, the step of extracting the viseme features using the first images includes:

generating a plurality of mouth-related portion embeddings corresponding to the first images, wherein each mouth-related portion embedding includes a first element generated using the depth information of the tongue; and

tracking deformation of the mouth-related portion such that context of the utterance reflected in the mouth-related portion embeddings is considered using a recurrent neural network (RNN), to generate the viseme features.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a diagram illustrating a mobile phone being used as a human-machine interface (HMI) system by a human, and hardware modules of the HMI system in accordance with an embodiment of the present disclosure.

FIG. 2 is a diagram illustrating a plurality of images including at least a mouth-related portion of the human speaking an utterance in accordance with an embodiment of the present disclosure.

FIG. 3 is a block diagram illustrating software modules of an HMI control module and associated hardware modules of the HMI system in accordance with an embodiment of the present disclosure.

FIG. 4 is a block diagram illustrating a neural network model in a speech recognition module in the HMI system in accordance with an embodiment of the present disclosure.

FIG. 5 is block diagram illustrating a neural network model in a speech recognition module in the HMI system in accordance with another embodiment of the present disclosure.

FIG. 6 is a flowchart illustrating a method for human-machine interaction in accordance with an embodiment of the present disclosure.

### DETAILED DESCRIPTION OF PREFERRED EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the invention.

As used here, the term “using” refers to a case in which an object is directly employed for performing an operation, or a case in which the object is modified by at least one intervening operation and the modified object is directly employed to perform the operation.

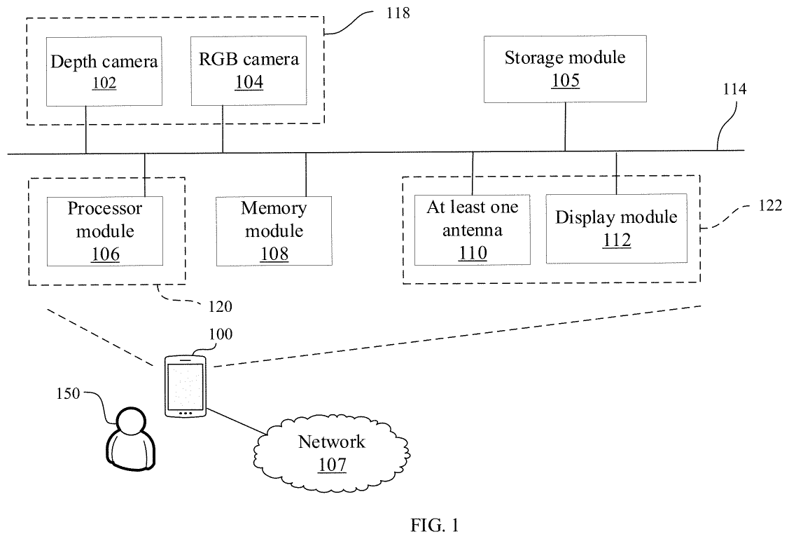

FIG. 1 is a diagram illustrating a mobile phone 100 being used as a human-machine interface (HMI) system by a human 150, and hardware modules of the HMI system in accordance with an embodiment of the present disclosure. Referring to FIG. 1, the human 150 uses the mobile phone 100 to serve as the HMI system that allows the human 150 to interact with HMI outputting modules 122 in the HMI system through visual speech. The mobile phone 100 includes a depth camera 102, an RGB camera 104, a storage module 105, a processor module 106, a memory module 108, at least one antenna 110, a display module 112, and a bus 114. The HMI system includes an HMI inputting module 118, an HMI control module 120, and the HMI outputting modules 122, and is capable of using an alternative source, such as the storage module 105, or a network 170.

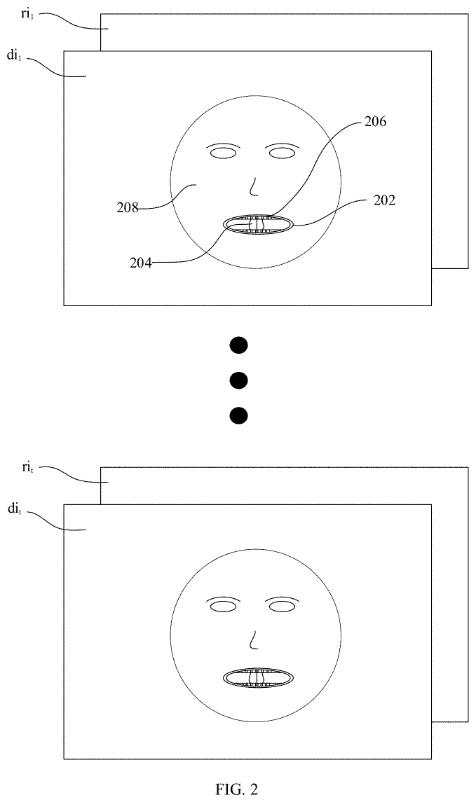

The depth camera 102 is configured to generate a plurality of images di₁ to diₜ (shown in FIG. 2) including at least a mouth-related portion of a human speaking an utterance. Each of the images di₁ to diₜ has depth information. The depth camera 102 may be an infrared (IR) camera that generates infrared light that illuminates at least the mouth-related portion of the human 150 when the human 150 speaking an utterance, and capture the images di₁ to diₜ. Examples of the IR camera include a time of flight camera and a structured light camera. The depth information may further be augmented with luminance information. Alternatively, the depth camera 102 may be a single RGB camera. Examples of the single RGB camera are described in more detail in “Depth map prediction from a single image using a multi-scale deep network,” David Eigen, Christian Puhrsch, and Rob Fergus, arXiv preprint arXiv: 1406.2283v1, 2014. Still alternatively, the depth camera 102 may be a stereo camera formed by, for example, two RGB cameras.

The RGB camera 104 is configured to capture a plurality of images ri₁ to riₜ (shown in FIG. 2) including at least a mouth-related portion of the human 150 speaking the utterance. Each of the images ri₁ to riₜ has color information. The RGB camera 104 may alternatively be replaced by other types of color cameras such as a CMYK camera. The RGB camera 104 and the depth camera 102 may be separate cameras configured such that objects in the images ri₁ to riₜ correspond to objects in the images di₁ to diₜ. The color information in each image ri₁, . . . , or riₜ augments the depth information in a corresponding image di₁, . . . , or diₜ. The RGB camera 104 and the depth camera 102 may alternatively be combined into an RGBD camera. The RGB camera 104 may be optional.

The depth camera 102 and the RGB camera 104 serve as the HMI inputting module 118 for inputting images di₁ to diₜ and images ri₁ to riₜ. The human 150 may speak the utterance silently or with sound. Because the depth camera 102 uses the infrared light to illuminate the human 150, the HMI inputting module 118 allows the human 150 to be located in an environment with poor light condition. The images di₁ to diₜ and the images ri₁ to riₜ may be used real-time, such as for speech dictation, or recorded and used later, such as for transcribing a video. When the images di₁ to diₜ and the images ri₁ to riₜ are recorded for later use, the HMI control module 120 may not receive the images di₁ to diₜ and the images ri₁ to riₜ directly from the HMI inputting module 118, and may receive the images di₁ to diₜ and the images ri₁ to riₜ from the alternative source such as the storage module 105 or a network 170.

The memory module 108 may be a non-transitory computer-readable medium that includes at least one memory storing program instructions executable by the processor module 106. The processor module 106 includes at least one processor that send signals directly or indirectly to and/or receives signals directly or indirectly from the depth camera 102, the RGB camera 104, the storage module 105, the memory module 108, the at least one antenna 110, the display module 112 via the bus 114. The at least one processor is configured to execute the program instructions which configure the at least one processor as an HMI control module 120. The HMI control module 120 controls the HMI inputting module 118 to generate the images di₁ to diₜ and the images ri₁ to riₜ, perform speech recognition for the images di₁ to diₜ and the images ri₁ to riₜ, and controls the HMI outputting modules 122 to generate a response based on a result of speech recognition.

The at least one antenna 110 is configured to generate at least one radio signal carrying information directly or indirectly derived from the result of speech recognition. The at least one antenna 110 serves as one of the HMI outputting modules 122. When the response is, for example, at least one cellular radio signal, the at least one cellular radio signal can carry, for example, content information directly derived from a dictation instruction to send, for example, a (short message service) SMS message. When the response is, for example, at least one Wi-Fi radio signal, the at least one Wi-Fi radio signal can carry, for example, keyword information directly derived from a dictation instruction to search the internet with the keyword. The display module 112 is configured to generate light carrying information directly or indirectly derived from the result of speech recognition. The display module 112 serves as one of the HMI outputting modules 122. When the response is, for example, light of video being displayed, the light of the video being displayed can carry, for example, desired to be viewed content indirectly derived from a dictation instruction to, for example, play or pause the video. When the response is, for example, light of displayed images, the light of the displayed images can carry, for example, text being input to the mobile phone 100 derived directly from the result of speech recognition.

The HMI system in FIG. 1 is the mobile phone 100. Other types of HMI systems such as a video game system that does not integrate an HMI inputting module, an HMI control module, and an HMI outputting module into one apparatus are within the contemplated scope of the present disclosure.

FIG. 2 is a diagram illustrating the images di₁ to diₜ and images ri₁ to riₜ including at least the mouth-related portion of the human 150 (shown in FIG. 1) speaking the utterance in accordance with an embodiment of the present disclosure. The images di₁ to diₜ are captured by the depth camera 102 (shown in FIG. 1). Each of the images di₁ to diₜ has the depth information. The depth information reflects how measured units of the at least the mouth-related portion of the human 150 are positioned front-to-back with respect to the human 150. The mouth-related portion of the human 150 includes a tongue 204. The mouth-related portion of the human 150 may further include lips 202, teeth 206, and facial muscles 208. The images di₁ to diₜ include a face of the human 150 speaking the utterance. The images ri₁ to riₜ are captured by the RGB camera 104. Each of the images ri₁ to riₜ has color information. The color information reflects how measured units of the at least the mouth-related portion of the human 150 differ in color. For simplicity, only the face of the human 150 speaking the utterance is shown in the images di₁ to diₜ, and other objects such as other body portions of the human 150 and other humans are hidden.

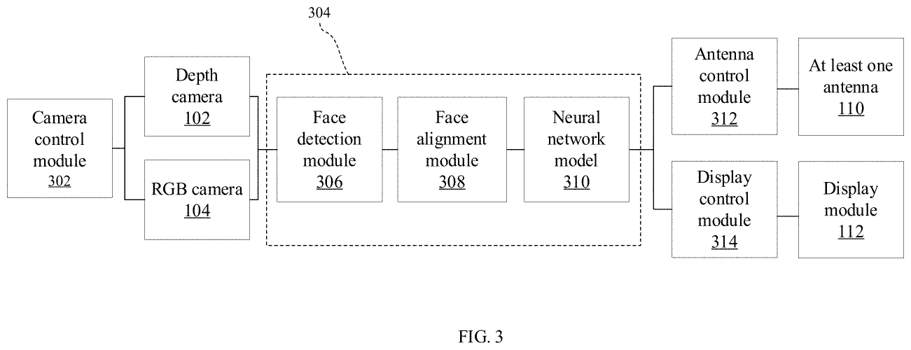

FIG. 3 is a block diagram illustrating software modules of the HMI control module 120 (shown in FIG. 1) and associated hardware modules of the HMI system in accordance with an embodiment of the present disclosure. The HMI control module 120 includes a camera control module 302, a speech recognition module 304, an antenna control module 312, and a display control module 314. The speech recognition module 304 includes a face detection module 306, a face alignment module 308, and a neural network model 310.

The camera control module 302 is configured to cause the depth camera 102 to generate the infrared light that illuminates at least the mouth-related portion of the human 150 (shown in FIG. 1) when the human 150 speaking the utterance, and capture the images di₁ to diₜ (shown in FIG. 2), and cause the RGB camera 104 to capture the images ri₁ to riₜ (shown in FIG. 2).

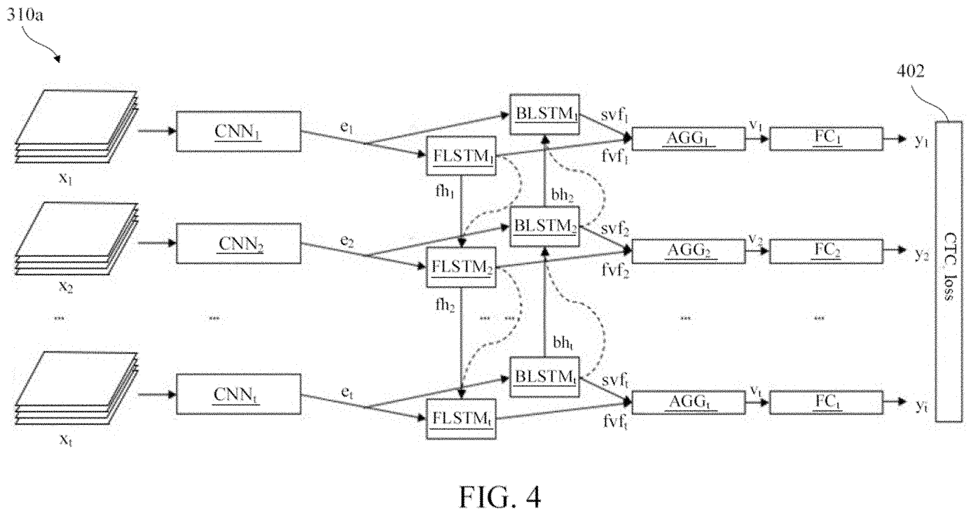

The speech recognition module 304 is configured to perform speech recognition for the images ri₁ to riₜ and the images di₁ to diₜ. The face detection module 306 is configured to detect a face of the human 150 in a scene for each of the images di₁ to diₜ and the images ri₁ to riₜ. The face alignment module 308 is configured to align detected faces with respect to a reference to generate a plurality of images x₁ to xₜ (shown in FIG. 4) with RGBD channels. The images x₁ to xₜ may include only the face of the human 150 speaking the utterance and have a consistent size, or may include only a portion of the face of the human 150 speaking the utterance and have a consistent size, through, for example, cropping and scaling performed during one or both of face detection and face alignment. The portion of the face spans from a nose of the human 150 to a chin of the human 150. The face alignment module 308 may not identify a set of facial landmarks for each of the detected faces. The neural network model 310 is configured to receive a temporal input sequence which is the images x₁ to xₜ, and outputs a sequence of words using deep learning.

The antenna control module 312 is configured to cause the at least one antenna 110 to generate the response based on the sequence of words being the result of speech recognition. The display control module 314 is configured to cause the display module 112 to generate the response based on the sequence of words being the result of speech recognition.

FIG. 4 is a block diagram illustrating the neural network model 310 in the speech recognition module 304 (shown in FIG. 3) in the HMI system in accordance with an embodiment of the present disclosure. Referring to FIG. 4, the neural network model 310 includes a plurality of convolutional neural networks (CNN) CNN₁ to CNNt, a recurrent neural network (RNN) formed by a plurality of forward long short-term memory (LSTM) units FLSTM₁ to FLSTMt and a plurality of backward LSTM units BLSTM₁ to BLSTMt, a plurality of aggregation units AGG₁ to AGGt, a plurality of fully connected networks FC₁ to FCt, and a connectionist temporal classification (CTC) loss layer 402.

Each of the CNNs CNN1 to CNNt is configured to extract features from a corresponding image x₁, . . . , or xₜ of the images x₁ to xₜ and map the corresponding image x₁, . . . , or xₜ to a corresponding mouth-related portion embedding e₁, . . . , or eₜ, which is a vector in a mouth-related portion embedding space. The corresponding mouth-related portion embedding e₁, . . . , or eₜ includes elements each of which is a quantified information of a characteristic of the mouth-related portion described with reference to FIG. 2. The characteristic of the mouth-related portion may be a one-dimensional (1D), two-dimensional (2D), or three-dimensional (3D) characteristic of the mouth-related portion. Depth information of the corresponding image x₁, . . . , or xₜ can be used to calculate quantified information of a 1D characteristic, 2D characteristic, or 3D characteristic of the mouth-related portion. Color information of the corresponding image x₁, . . . , or xₜ can be used to calculate quantified information of a 1D characteristic, or 2D characteristic of the mouth-related portion. Both the depth information and the color information of the corresponding image x₁, . . . , or xₜ can be used to calculate quantified information of a 1D characteristic, 2D characteristic, or 3D characteristic of the mouth-related portion. The characteristic of the mouth-related portion may, for example, be a shape or location of the lips 202, a shape or location of the tongue 204, a shape or location of the teeth 206, and a shape or location of the facial muscles 208. The location of, for example, the tongue 204 may be a relative location of the tongue 204 with respect to, for example, the teeth 206. The relative location of the tongue 204 with respect to the teeth 206 may be used to distinguish, for example, “leg” from “egg” in the utterance. Depth information may be used to better track the deformation of the mouth-related portion while color information may be more edge-aware for the shapes of the mouth-related portion.

Each of the CNNs CNN₁ to CNNt includes a plurality of interleaved layers of convolutions (e.g., spatial or spatiotemporal convolutions), a plurality of non-linear activation functions (e.g., ReLU, PReLU), max-pooling layers, and a plurality of optional fully connected layers. Examples of the layers of each of the CNNs CNN1 to CNNt are described in more detail in “FaceNet: A unified embedding for face recognition and clustering,” Florian Schroff, Dmitry Kalenichenko, and James Philbin, arXiv preprint arXiv: 1503.03832, 2015.

The RNN is configured to track deformation of the mouth-related portion such that context of the utterance reflected in the mouth-related portion embeddings e₁ to eₜ is considered, to generate a first plurality of viseme features fvf1 to fvfₜ and a second plurality of viseme features svf₁ to svfₜ. A viseme feature is a high-level feature that describes deformation of the mouth-related portion corresponding to a viseme.

The RNN is a bidirectional LSTM including the LSTM units FLSTM₁ to FLSTMₜ and LSTM units BLSTM₁ to BLSTMₜ. A forward LSTM unit FLSTM₁ is configured to receive the mouth-related portion embedding e₁, and generate a forward hidden state fh₁, and a first viseme feature fvf₁. Each forward LSTM unit FLSTM₂, . . . , or FLSTMₜ₋₁ is configured to receive the corresponding mouth-related portion embedding e₂, . . . , or eₜ₋₁, and a forward hidden state fh₁, . . . , or fhₜ₋₂, and generate a forward hidden state fh₂, . . . , or fhₜ₋₁, and a first viseme feature fvf₂, . . . , or fvfₜ₋₁. A forward LSTM unit FLSTMₜ is configured to receive the mouth-related portion embedding eₜ and the forward hidden state fhₜ₋₁, and generate a first viseme feature fvfₜ. A backward LSTM unit BLSTMₜ is configured to receive the mouth-related portion embedding eₜ, and generate a backward hidden state bhₜ, and a second viseme feature svfₜ. Each backward LSTM unit BLSTMₜ₋₁, . . . , or BLSTM₂ is configured to receive the corresponding mouth-related portion embedding eₜ₋₁, . . . , or e₂, and a backward hidden state bhₜ, . . . , or bh₃, and generate a backward hidden state bhₜ₋₁, . . . , or bh₂, and a second viseme feature svfₜ₋₁, . . . , or svf₂. A backward LSTM unit BLSTM₁ is configured to receive the mouth-related portion embedding e₁ and the backward hidden state bh₂, and generate a second viseme feature svf₁.

Examples of each of the forward LSTM units FLSTM₁ to FLSTMₜ, and the backward LSTM units BLSTM1 to BLSTMₜ are described in more detail in “Speech recognition with deep recurrent neural networks,” Graves A, Mohamed A R, Hinton G, In IEEE International Conference on Acoustics, Speech and Signal Processing, pp. 6645-6649, 2016.

The RNN in FIG. 4 is a bidirectional LSTM including only one bidirectional LSTM layer. Other types of RNN such as a bidirectional LSTM including a stack of bidirectional LSTM layers, a unidirectional LSTM, a bidirectional gated recurrent unit, a unidirectional gated recurrent unit are within the contemplated scope of the present disclosure.

Each of the aggregation units AGG₁ to AGGₜ is configured to aggregate the corresponding first viseme feature fvf₁, . . . , or fvfₜ and the corresponding second viseme feature svf₁, . . . , or svfₜ, to generate a corresponding aggregated output v₁, . . . , or vₜ. Each of the aggregation units AGG₁ to AGGₜ may aggregate the corresponding first viseme feature fvf₁, . . . , or fvfₜ and the corresponding second viseme feature svf₁, . . . , or svfₜ through concatenation.

Each of the fully connected networks FC₁ to FCₜ is configured to map the corresponding aggregated output v₁, . . . , or vₜ to a character space, and determine a probability distribution y₁, . . . , or yₜ of characters mapped to a first viseme feature fvf₁, . . . , or fvfₜ and/or a second viseme feature svf₁, . . . , or svfₜ. Each of the fully connected networks FC₁ to FCₜ may be a multiple layer perceptron (MLP). The probability distribution of the output character may be determined using a softmax function.

The CTC loss layer 402 is configured to perform the following. A plurality of probability distributions y₁ to yₜ of characters mapped to the first plurality of viseme features fvf₁ to fvfₜ and/or the second plurality of viseme features svf₁ to svfₜ is received. The output character may be an alphabet or a blank token. A probability distribution of strings is obtained. Each string is obtained by marginalizing over all character sequences that are defined equivalent to this string. A sequence of words is obtained using the probability distribution of the strings. The sequence of words includes at least one word. The sequence of words may be a phrase or a sentence. A language model may be employed to obtain the sequence of words. Examples of the CTC loss layer 402 are described in more detail in “Connectionist temporal classification: labelling unsegmented sequence data with recurrent neural networks,” Graves, S. Fernandez, F. Gomez, and J. Schmidhuber, In ICML, pp. 369-376, 2006.

The neural network model 310 is trained end-to-end by minimizing CTC loss. After training, parameters of the neural network model 310 are frozen, and the neural network model 310 is deployed to the mobile phone 100 (shown in FIG. 1).

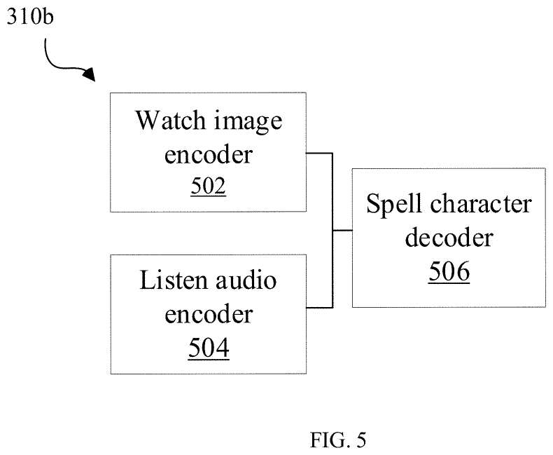

FIG. 5 is block diagram illustrating a neural network model 310b in a speech recognition module 304 (shown in FIG. 3) in the HMI system in accordance with another embodiment of the present disclosure. Referring to FIG. 5, the neural network model 310b includes a watch image encoder 502, a listen audio encoder 504, and a spell character decoder 506. The watch image encoder 502 is configured to extract a plurality of viseme features from images x₁ to xₜ (exemplarily shown in FIG. 4). Each viseme feature is obtained using depth information of the mouth-related portion (described with reference to FIG. 2) of an image x₁, . . . , or xₜ. The listen audio encoder 504 is configured to extract a plurality of audio features using an audio including sound of the utterance. The spell character decoder 506 is configured to determine a sequence of words corresponding to the utterance using the viseme features and the audio features. The watch image encoder 502, the listen audio encoder 504, and the spell character decoder 506 are trained by minimizing a conditional loss. Examples of an encoder-decoder based neural network model for speech recognition are described in more detail in “Lip reading sentences in the wild,” Joon Son Chung, Andrew Senior, Oriol Vinyals, and Andrew Zisserman, arXiv preprint arXiv: 1611.05358v2, 2017.

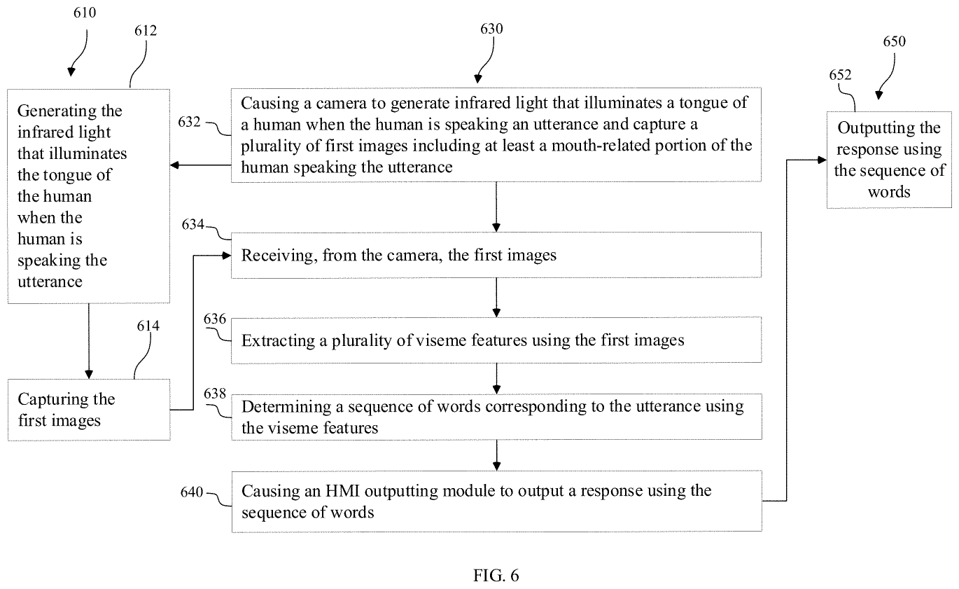

FIG. 6 is a flowchart illustrating a method for human-machine interaction in accordance with an embodiment of the present disclosure. Referring to FIGS. 1 to 5, the method for human-machine interaction includes a method 610 performed by the HMI inputting module 118, a method 630 performed by the HMI control module 120, and a method 650 performed by the HMI outputting modules 122.

In step 632, a camera is caused to generate infrared light that illuminates a tongue of a human when the human is speaking an utterance and capture a plurality of first images including at least a mouth-related portion of the human speaking the utterance by the camera control module 302. The camera is the depth camera 102.

In step 612, the infrared light that illuminates the tongue of the human when the human is speaking the utterance is generated by the camera.

In step 614, the first images are captured by the camera.

In step 634, the first images are received from the camera by the speech recognition module 304.

In step 636, a plurality of viseme features are extracted using the first images. The step 636 may include generating a plurality of mouth-related portion embeddings corresponding to the first images by the face detection module 306, the face alignment module 308, and the CNNs CNN₁ to CNNₜ; and tracking deformation of the mouth-related portion such that context of the utterance reflected in the mouth-related portion embeddings is considered using an RNN, to generate the viseme features by the RNN and the aggregation units AGG₁ to AGGₜ. The RNN is formed by the forward LSTM units FLSTM₁ to FLSTMₜ and the backward LSTM units BLSTM₁ to BLSTMₜ. Alternatively, the step 636 may include generating a plurality of second images by the face detection module 306, the face alignment module 308 using the first images; and extracting the viseme features from the second images by the watch image encoder 502.

In step 638, a sequence of words corresponding to the utterance is determined using the viseme features. The step 638 may include determining a plurality of probability distributions of characters mapped to the viseme features by the fully connected networks FC₁ to FCₜ; and determining the sequence of words using the probability distributions of the characters mapped to the viseme features by the CTC loss layer 402. Alternatively, the step 638 may be performed by the spell character decoder 506.

In step 640, an HMI outputting module is caused to output a response using the sequence of words. When the HMI outputting module is the at least one antenna 110, the at least one antenna 110 is caused to generate the response by the antenna control module 312. When the HMI outputting module is the display module 112, the display module 112 is caused to generate the response by the display control module 314.

In step 652, the response is output by the HMI outputting module using the sequence of words.

Alternatively, in step 632, at least one camera is caused to generate infrared light that illuminates a tongue of a human when the human is speaking an utterance and capture a plurality of first images including at least a mouth-related portion of the human speaking the utterance by the camera control module 302. The at least one camera includes the depth camera 102 and the RGB camera 104. Each image set is₁, . . . , or ist includes an image di₁, . . . , or diₜ and an image ri₁, . . . , or riₜ in FIG. 2. In step 612, the infrared light that illuminates the mouth-related portion of the human when the human is uttering the voice is generated by the depth camera 102. In step 614, the image sets are captured by the depth camera 102 and the RGB camera 104. In step 634, the image sets are received from the at least one camera by the speech recognition module 304. In step 636, a plurality of viseme features are extracted using the image sets by the face detection module 306, the face alignment module 308, the CNNs CNN₁ to CNNₜ, the RNN, and the aggregation units AGG₁ to AGGₜ. The RNN is formed by the forward LSTM units FLSTM₁ to FLSTMₜ and the backward LSTM units BLSTM₁ to BLSTMₜ. Alternatively, in step 636, a plurality of viseme features are extracted using the image sets by the face detection module 306, the face alignment module 308, and the watch image encoder 502.

Some embodiments have one or a combination of the following features and/or advantages. In an embodiment, speech recognition is performed by: receiving a plurality of images including at least a mouth-related portion of a human speaking an utterance, wherein each image has depth information; and extracting a plurality of viseme features using the first images, wherein one of the viseme features is obtained using depth information of a tongue of the human in the depth information of a first image of the first images. With depth information, deformation of the mouth-related portion can be tracked such that 3D shapes and subtle motions of the mouth-related portion are considered. Therefore, certain ambiguous words (e.g. “leg” vs. “egg”) can be distinguished. In an embodiment, a depth camera illuminates the mouth-related portion of the human when the human is speaking the utterance with infrared light and captures the images. Therefore, the human is allowed to speak the utterance in an environment with poor light condition.

A person having ordinary skill in the art understands that each of the units, modules, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure.

It is understood by a person having ordinary skill in the art that he/she can refer to the working processes of the system, device, and module in the above-mentioned embodiment since the working processes of the above-mentioned system, device, and module are basically the same. For easy description and simplicity, these working processes will not be detailed.

It is understood that the disclosed system, device, and method in the embodiments of the present disclosure can be realized with other ways. The above-mentioned embodiments are exemplary only. The division of the modules is merely based on logical functions while other divisions exist in realization. It is possible that a plurality of modules or components are combined or integrated in another system. It is also possible that some characteristics are omitted or skipped. On the other hand, the displayed or discussed mutual coupling, direct coupling, or communicative coupling operate through some ports, devices, or modules whether indirectly or communicatively by ways of electrical, mechanical, or other kinds of forms.

The modules as separating components for explanation are or are not physically separated. The modules for display are or are not physical modules, that is, located in one place or distributed on a plurality of network modules. Some or all of the modules are used according to the purposes of the embodiments.

Moreover, each of the functional modules in each of the embodiments can be integrated in one processing module, physically independent, or integrated in one processing module with two or more than two modules.

If the software function module is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method, comprising:
receiving, by at least one processor, a plurality of first images comprising at least a mouth-related portion of a human speaking an utterance, wherein each first image has depth information;
extracting, by the at least one processor, a plurality of viseme features using the first images, wherein one of the viseme features is obtained using depth information of a tongue of the human in the depth information of a first image of the first images;
determining, by the at least one processor, a sequence of words corresponding to the utterance using the viseme features, wherein the sequence of words comprises at least one word; and
outputting, by a human-machine interface (HMI) outputting module, a response using the sequence of words.

2. The method of claim 1, further comprising:
generating, by a camera, infrared light that illuminates the tongue of the human when the human is speaking the utterance; and
capturing, by the camera, the first images.

3. The method of claim 1, wherein the step of receiving, by the at least one processor, the first images comprises:
receiving, by the at least one processor, a plurality of image sets, wherein each image set comprises a corresponding second image of the first images, and a corresponding third image, and the corresponding third image has color information augmenting the depth information of the corresponding second image; and
the step of extracting, by the at least one processor, the viseme features using the first images comprises:
extracting, by the at least one processor, the viseme features using the image sets, wherein the one of the viseme features is obtained using the depth information and color information of the tongue correspondingly in the depth information and the color information of a first image set of the image sets.

4. The method of claim 1, wherein the step of extracting, by the at least one processor, the viseme features using the first images comprises:
generating, by the at least one processor, a plurality of mouth-related portion embeddings corresponding to the first images, wherein each mouth-related portion embedding comprises a first element generated using the depth information of the tongue; and
tracking, by the at least one processor, deformation of the mouth-related portion such that context of the utterance reflected in the mouth-related portion embeddings is considered using a recurrent neural network (RNN), to generate the viseme features.

5. The method of claim 4, wherein the RNN comprises a bidirectional long short-term memory (LSTM) network.

6. The method of claim 1, wherein the step of determining, by the at least one processor, the sequence of words corresponding to the utterance using the viseme features comprises:
determining, by the least one processor, a plurality of probability distributions of characters mapped to the viseme features; and
determining, by a connectionist temporal classification (CTC) loss layer implemented by the at least one processor, the sequence of words using the probability distributions of the characters mapped to the viseme features.

7. The method of claim 1, wherein the step of determining, by the at least one processor, the sequence of words corresponding to the utterance using the viseme features comprises:
determining, by a decoder implemented by the at least one processor, the sequence of words corresponding to the utterance using the viseme features.

8. The method of claim 1, wherein the one of the viseme features is obtained using depth information of the tongue, lips, teeth, and facial muscles of the human in the depth information of the first image of the first images.

9. A system, comprising:
at least one memory configured to store program instructions;
at least one processor configured to execute the program instructions, which cause the at least one processor to perform steps comprising:
receiving a plurality of first images comprising at least a mouth-related portion of a human speaking an utterance, wherein each first image has depth information;
extracting a plurality of viseme features using the first images, wherein one of the viseme features is obtained using depth information of a tongue of the human in the depth information of a first image of the first images; and
determining a sequence of words corresponding to the utterance using the viseme features, wherein the sequence of words comprises at least one word; and
a human-machine interface (HMI) outputting module configured to output a response using the sequence of words.

10. The system of claim 9, further comprising:
a camera configured to:
generate infrared light that illuminates the tongue of the human when the human is speaking the utterance; and
capture the first images.

11. The system of claim 9, wherein the step of receiving the first images comprises:
receiving a plurality of image sets, wherein each image set comprises a corresponding second image of the first images, and a corresponding third image, and the corresponding third image has color information augmenting the depth information of the corresponding second image; and
the step of extracting the viseme features using the first images comprises:
extracting the viseme features using the image sets, wherein the one of the viseme features is obtained using the depth information and color information of the tongue correspondingly in the depth information and the color information of a first image set of the image sets.

12. The system of claim 9, wherein the step of extracting the viseme features using the first images comprises:
generating a plurality of mouth-related portion embeddings corresponding to the first images, wherein each mouth-related portion embedding comprises a first element generated using the depth information of the tongue; and
tracking deformation of the mouth-related portion such that context of the utterance reflected in the mouth-related portion embeddings is considered using a recurrent neural network (RNN), to generate the viseme features.

13. The system of claim 12, wherein the RNN comprises a bidirectional long short-term memory (LSTM) network.

14. The system of claim 9, wherein the step of determining the sequence of words corresponding to the utterance using the viseme features comprises:
determining a plurality of probability distributions of characters mapped to the viseme features; and
determining, by a connectionist temporal classification (CTC) loss layer, the sequence of words using the probability distributions of the characters mapped to the viseme features.

15. The system of claim 9, wherein the step of determining the sequence of words corresponding to the utterance using the viseme features comprises:
determining, by a decoder, the sequence of words corresponding to the utterance using the viseme features.

16. The system of claim 9, wherein the one of the viseme features is obtained using depth information of the tongue, lips, teeth, and facial muscles of the human in the depth information of the first image of the first images.

17. A non-transitory computer-readable medium with program instructions stored thereon, that when executed by at least one processor, cause the at least one processor to perform steps comprising:
receiving a plurality of first images comprising at least a mouth-related portion of a human speaking an utterance, wherein each first image has depth information;
extracting a plurality of viseme features using the first images, wherein one of the viseme features is obtained using depth information of a tongue of the human in the depth information of a first image of the first images;
determining a sequence of words corresponding to the utterance using the viseme features, wherein the sequence of words comprises at least one word; and
causing a human-machine interface (HMI) outputting module to output a response using the sequence of words.

18. The non-transitory computer-readable medium of claim 17, wherein the steps further comprise:
causing a camera to generate infrared light that illuminates the tongue of the human when the human is speaking the utterance and capture the first images.

19. The non-transitory computer-readable medium of claim 17, wherein the step of receiving the first images comprises:
receiving a plurality of image sets, wherein each image set comprises a corresponding second image of the first images, and a corresponding third image, and the corresponding third image has color information augmenting the depth information of the corresponding second image; and
the step of extracting the viseme features using the first images comprises:
extracting the viseme features using the image sets, wherein the one of the viseme features is obtained using the depth information and color information of the tongue correspondingly in the depth information and the color information of a first image set of the image sets.

20. The non-transitory computer-readable medium of claim 17, wherein the step of extracting the viseme features using the first images comprises:
generating a plurality of mouth-related portion embeddings corresponding to the first images, wherein each mouth-related portion embedding comprises a first element generated using the depth information of the tongue; and
tracking deformation of the mouth-related portion such that context of the utterance reflected in the mouth-related portion embeddings is considered using a recurrent neural network (RNN), to generate the viseme features.
